(19) United States
(12) Patent Application Publication
(10) Pub. No.: US 2009/0109001 A1
(43) Pub. Date: Apr. 30, 2009

(54) Wireless IC tag, wireless IC tag system and operation method for wireless IC tag

(75) Inventors: Kazuki Watanabe, Hino (JP); Masaaki Yamamoto, Kokubunji (JP); Takanori Yamazoe, Hadano (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/222,657

(22) Filed: Aug. 13, 2008

(30) Foreign Application Priority Data
Oct. 31, 2007 (JP) JP 2007-282723

(51) Int. Cl. H04Q 5/22

(52) U.S. Cl. 340/10.1

(57) ABSTRACT

A wireless IC tag system according to the present invention is provided with a wireless IC tag, a reader/writer device and a high-frequency signal output device. The reader/writer device outputs a first high-frequency signal. The high-frequency signal output device outputs a second high-frequency signal only during a period when the reader/writer device outputs the first high-frequency signal. The wireless IC tag is provided with an antenna, a power supply circuit and a communication circuit. The antenna receives the first and second high-frequency signals. The power supply circuit generates a power supply voltage from the first and second high-frequency signals. The communication circuit transmits and receives an information signal to and from the reader/writer device by utilizing the first high-frequency signal.

### CROSS-REFERENCE TO RELATED APPLICATION

The present application claims priority from Japanese Patent Application No. JP 2007-282723 filed on Oct. 31, 2007, the content of which is hereby incorporated by reference into this application.

### TECHNICAL FIELD OF THE INVENTION

The present invention relates to a wireless IC tag system in which data is transmitted and received between a wireless IC tag attached to an article or the like and a reader/writer device.

### BACKGROUND OF THE INVENTION

The wireless IC tag having an IC chip and an antenna incorporated therein exchanges information between a reader/writer device and the IC chip, retains the data transmitted from the reader/writer device, and transmits the data retained in the wireless IC tag. The wireless IC tag system as mentioned above is utilized for an article management, an inventory management and others in a production line, a shipping storage and others.

In the case of a passive type wireless IC tag which does not have a battery incorporated therein, a high-frequency signal supplied from a reader/writer device is received by an antenna, and an internal voltage necessary for operating an internal circuit is generated from the high-frequency signal.

Since the reader/writer device having a power supply performs a transmission operation to a wireless IC tag, a certain degree of communication distance can be secured in the transmission from the reader/writer device to the wireless IC tag. On the other hand, since the wireless IC tag performs the transmission operation by the energy obtained from the reader/writer device, the communication distance is shorter in the transmission from the wireless IC tag to the reader/writer device. In addition, an electric power that the wireless IC tag can receive becomes insufficient due to the distance from the reader/writer device and the influence of a circumferential environment. For its prevention, a large amount of energy has to be given from the reader/writer device to the wireless IC tag.

However, in the wireless communication device, a usable frequency and an output level are defined by law. Accordingly, the wireless IC tag and the reader/writer device have to satisfy the defined conditions, and it is impossible to supply a predetermined energy or more to the wireless IC tag from the reader/writer device. For example, in the wireless communication device that does not require a license for a user, an electric field strength at a distance of 3 m is restricted to 500 μV/m (322 MHz or less) or the electric power is restricted to 10 mW output or less.

As a technology for solving the problem mentioned above and increasing the communication distance, Japanese Patent Application Laid-Open Publication No. 2003-124841 (Patent Document 1) is known. In the patent document 1, the IC tag wirelessly communicates with a tag reader by using a first frequency, and an energy of a wireless radio wave of a second frequency emitted from an energy transmitting device is utilized as the energy for the wireless communication with the tag reader, thereby increasing the communication distance of the wireless communication device. Also, in the patent document 1, a wireless communication device with a data system that uses a radio wave band of a cellular phone and charges in accordance with a transmitted and received data packet is used as a wireless radio wave emitting device.

### SUMMARY OF THE INVENTION

Incidentally, the study of the technology for the wireless IC tag system as mentioned above by the inventors of the present invention has revealed the following.

In the patent document 1, the IC tag wirelessly communicates with the tag reader by using the first frequency, and the radio wave energy of the second frequency emitted from the energy transmitting device is utilized as the energy for the wireless communication with the tag reader.

Accordingly, in order to handle a plurality of frequencies, an antenna unit which picks up the radio wave of the first frequency emitted from the tag reader, a tuning and picking up unit which picks up the radio wave of the second frequency emitted from the energy transmitting device, and a frequency converting unit which converts an electric signal of the second frequency into an electric signal of the first frequency are provided in the patent document 1. However, when a plurality of frequency bands are to be handled, the number of components such as the tuning and picking up unit and the frequency converting unit as described in the patent document 1 is increased.

Therefore, an object of the present invention is to perform wireless communication and energy supply within a frequency band defined by an international standard specification shown by the following items 1) to 5), in order to prevent the increase in the number of components. Note that EPC Radio-Frequency Identity Protocols Class-1 Generation-2 UHF RFID Protocol for Communications at 860 MHz-960 MHz Version 1.0.9”, EPC global Inc., Jan. 31, 2005 (Non-Patent Document 1) is known as a relevant document to the international standard specification.

1) ISO/IEC 18000-2: 135 KHz or less

2) ISO/IEC 18000-3: 13.56 MHz

3) ISO/IEC 18000-4: 2.45 GHz

4) ISO/IEC 18000-6: 860-960 MHz

5) ISO/IEC 18000-7: 433 MHz

Further, another object of the present invention is to perform the wireless communication and the energy supply with a simpler configuration. The above and other objects and novel characteristics of the present invention will be apparent from the description of this specification and the accompanying drawings.

The typical ones of the inventions disclosed in this application will be briefly described as follows.

More specifically, the present invention provides a wireless IC tag comprising: an antenna; a power supply circuit; and a demodulation circuit, wherein the antenna receives a first radio wave obtained by amplitude modulating a carrier wave having a first frequency by an information signal and a second radio wave having a second frequency, wherein the power supply circuit generates a power supply voltage from a signal induced in the antenna by the first radio wave and the second radio wave, and wherein the demodulation circuit demodulates the information signal from the signal.

According to a typical embodiment, the wireless communication and the energy supply to the wireless IC tag can be performed within the frequency band defined by the international standard specification and with a simple configuration.

### BRIEF DESCRIPTIONS OF THE DRAWINGS

FIG. 1 is a diagram showing a basic configuration of a wireless IC tag system according to a first embodiment of the present invention;

FIG. 2 is a diagram showing a configuration of a wireless IC tag according to first to sixth embodiments of the present invention;

FIG. 3A is a diagram showing an example of a relation in frequency of high-frequency signals in the wireless IC tag system according to the present invention;

FIG. 3B is a diagram showing an example of a relation in frequency of high-frequency signals in the wireless IC tag system according to the present invention;

FIG. 4 is a diagram showing an example of a positional relationship between a reader/writer device and a high-frequency signal output device and an electric field strength in the wireless IC tag system according to the present invention;

FIG. 5 is a diagram showing a basic configuration of a wireless IC tag system according to a second embodiment of the present invention;

FIG. 6 is a diagram showing a basic configuration of a wireless IC tag system according to a third embodiment of the present invention;

FIG. 7A is a diagram showing an example of a control waveform of the high-frequency signal in the wireless IC tag system shown in FIG. 6;

FIG. 7B is a diagram showing an example of a control waveform of the high-frequency signal in the wireless IC tag system shown in FIG. 6;

FIG. 7C is a diagram showing an example of a control waveform of the high-frequency signal in the wireless IC tag system shown in FIG. 6;

FIG. 8 is a diagram showing a basic configuration of a wireless IC tag system according to a fourth embodiment of the present invention;

FIG. 9A is a diagram showing an example of a control waveform of the high-frequency signal in the wireless IC tag system shown in FIG. 8;

FIG. 9B is a diagram showing an example of a control waveform of the high-frequency signal in the wireless IC tag system shown in FIG. 8;

FIG. 9C is a diagram showing an example of a control waveform of the high-frequency signal in the wireless IC tag system shown in FIG. 8;

FIG. 9D is a diagram showing an example of a control waveform of the high-frequency signal in the wireless IC tag system shown in FIG. 8;

FIG. 10 is a diagram showing a basic configuration of a wireless IC tag system according to a fifth embodiment of the present invention;

FIG. 11 is a diagram showing a basic configuration of a wireless IC tag system according to a sixth embodiment of the present invention; and

FIG. 12 is a diagram showing another configuration example of the wireless IC tag.

### DESCRIPTIONS OF THE PREFERRED EMBODIMENTS

Hereinafter, embodiments of the present invention will be described in detail with reference to the accompanying drawings. Note that components having the same function are denoted by the same reference numbers throughout the drawings for describing the embodiments, and the repetitive description thereof will be omitted.

### First Embodiment

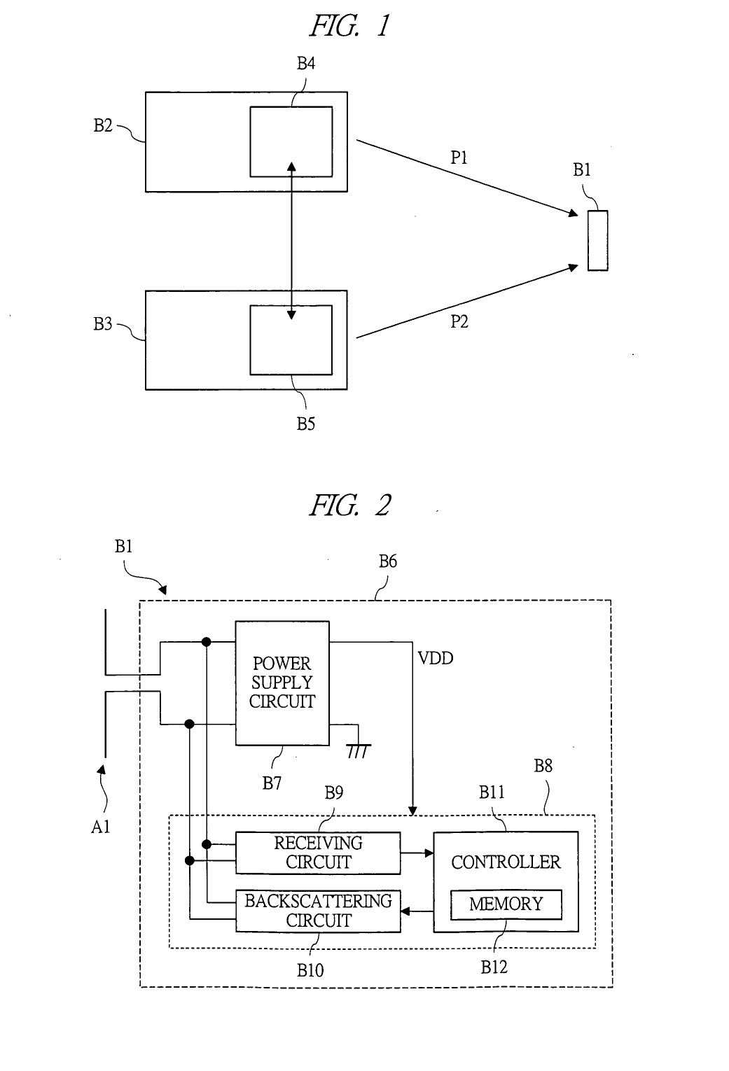

FIG. 1 shows a basic configuration of a wireless IC tag system according to a first embodiment of the present invention. In FIG. 1, B1 denotes a wireless IC tag, B2 denotes a reader/writer device (wireless communication device), and B3 denotes a high-frequency signal output device (wireless signal output device). The reader/writer device B2 is provided with an output circuit B4 composed of an antenna and an antenna drive circuit, and outputs a high-frequency signal P1. Further, an information signal by which the reader/writer device B2 reads out the data retained by the wireless IC tag B1, an information signal by which the reader/writer device B2 writes the data in the wireless IC tag B1, and the like are superposed on the high-frequency signal P1. The high-frequency signal output device B3 is provided with an output circuit B5 composed of an antenna and an antenna drive circuit, and outputs a high-frequency signal P2. The high-frequency signal P2 is output during a period when the high-frequency signal P1 output from the reader/writer device B2 is being output, and is controlled so that an output period of the high-frequency signal P2 is synchronized with an output period of the high-frequency signal P1, by a signal or the like in a wireless or wired form.

Desirably, the high-frequency signal P1 and the high-frequency signal P2 belong to a frequency band defined by the same standard specification. For example, in the case of complying with ISO/IEC 18000-6, they belong to the band of 860-960 MHz. The band is further classified within the frequency band defined by the standard specification, and a plurality of channels are allocated. Different channels are allocated to the usable frequency bands of the high-frequency signal P1 and the high-frequency signal P2. Accordingly, in each of the channels, an output level of the radio wave output by the reader is set within a range defined by law. With the configuration described above, since the high-frequency signal P1 output from the reader/writer device B2 and the high-frequency signal P2 output from the high-frequency signal output device B3 are supplied to the wireless IC tag B1, it is possible to increase the electric power received by the wireless IC tag B1. Note that, in FIG. 1, the reader/writer device B2 and the high-frequency signal output device B3 are shown as separated devices, but may be configured as an integrated device.

The wireless IC tag B1 receives the high-frequency signal P1 supplied in a form of a radio wave from the reader/writer device B2 and the high-frequency signal P2 supplied in a form of a radio wave from the high-frequency signal output device B3. Further, the wireless IC tag B1 demodulates the information signal superposed on the high-frequency signal P1, superposes the result of the signal processing performed in accordance with the information signal transmitted from the reader/writer device B2 on the high-frequency signal P1, and then returns the signal to the reader/writer device B2. Note that the wireless IC tag B1 is designed so as to receive the radio wave within the frequency band defined by the same standard specification. For example, in the case of complying with ISO/IEC 18000-6, it is designed to receive the radio wave of 860-960 MHz.

FIG. 2 shows a configuration of the wireless IC tag B1. The wireless IC tag B1 is composed of an antenna A1 and an IC chip B6, and the IC chip B6 is provided with a power supply circuit B7 and an internal circuit (communication circuit) B8.

The antenna A1 can receive the radio wave within the frequency band defined by the international standard specification mentioned above. The power supply circuit B7 rectifies the high-frequency signal received by the antenna A1 provided in the wireless IC tag and smoothes the rectified signal with a smoothing capacitor, thereby obtaining a power supply voltage VDD supplied to the internal circuit B8. Further, a regulator circuit to control the power supply voltage VDD so as not to reach a predetermined voltage or higher may be provided.

The internal circuit B8 is composed of a receiving circuit B9, a backscattering circuit B10 and a controller B11, and the controller B11 is provided with a memory B12 and the like.

The receiving circuit B9 has a demodulation function. The receiving circuit B9 rectifies, filters and binarizes the high-frequency signal received by the antenna A1 to demodulate only the information signal superposed on the high-frequency signal, thereby reproducing an information signal of a digital signal and supplying the signal to the controller B11. The controller B11 performs a signal processing in accordance with the information signal supplied from the receiving circuit B9, and supplies the processing result as the information signal of the digital signal to the backscattering circuit B10. The backscattering circuit B10 receives the information signal output from the controller B11 and superposes the information signal on the high-frequency signal received by the antenna A1, thereby transmitting the information signal to the reader/writer device B2. The reader/writer device B2 receives the information signal from the controller B11 in response to a change of reflection of the radio wave from the antenna A1. Further, the memory B12 is utilized for recording the information data in the controller B11, and the data is read, written and deleted by the controller B11.

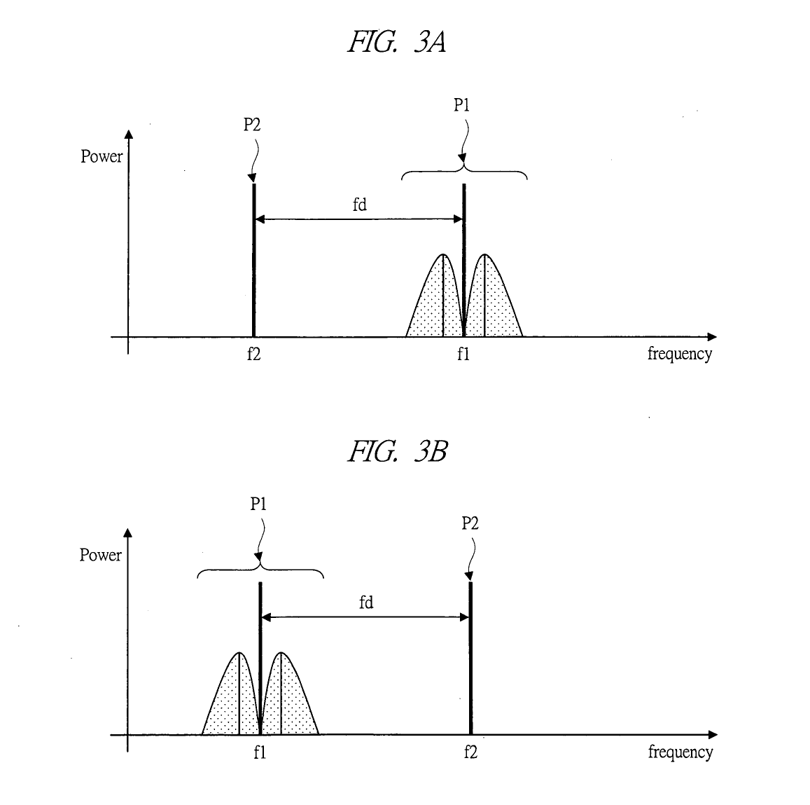

Next, the influence which the high-frequency signal P2 from the high-frequency signal output device B3 gives to the high-frequency signal P1 from the reader/writer device B2 will be described in the light of a frequency component. FIG. 3 shows a relation in frequency between the high-frequency signal P1 and the high-frequency signal P2 in the wireless IC tag system. FIG. 3A shows the case where the frequency of the high-frequency signal P1 is higher than the frequency of the high-frequency signal P2, and FIG. 3B shows the case where the frequency of the high-frequency signal P1 is lower than the frequency of the high-frequency signal P2.

The reader/writer device B2 outputs the high-frequency signal P1 in a form of superposing the information signal on a carrier wave to the wireless IC tag B1. For example, in the general wireless IC tag system complying with the international standard specification mentioned above, since the data transmitted from the reader/writer device B2 to the wireless IC tag B1 is expressed in a form of modulating the amplitude of a carrier wave, the high-frequency signal P1 is in a form having sideband waves around a carrier wave frequency f1.

On the other hand, since the high-frequency signal output device B3 outputs the high-frequency signal P2 constituted by a single frequency, it is mainly expressed by a center frequency f2. Since the antenna A1 provided in the wireless IC tag B1 simultaneously receives the high-frequency signals P1 and P2, the high-frequency signal generated in the antenna A1 is a combined wave of the high-frequency signal P1 and the high-frequency signal P2. As mentioned above, since the data transmitted from the reader/writer device B2 to the wireless IC tag B1 is expressed by the form of modulating the amplitude of the carrier wave, a signal generated by the difference fd between the center frequencies of the high-frequency signal P1 and the high-frequency signal P2 becomes, in the wireless IC tag B1, a noise component superposed on the information signal transmitted from the reader/writer device B2.

Accordingly, in the case where the difference fd between the center frequencies of the high-frequency signal P1 and the high-frequency signal P2 is small, there is the possibility that the wireless IC tag B1 cannot correctly receive the information signal transmitted from the reader/writer device B2. However, since the receiving circuit B9 provided in the wireless IC tag B1 has the filter circuit for filtering the high-frequency component as mentioned above, the noise generated by the difference between the center frequencies is removed by the filter circuit if the center frequency f2 of the high-frequency signal P2 is sufficiently separated from the center frequency f1 of the high-frequency signal P1, and the wireless IC tag B1 can receive the information signal from the reader/writer device B2.

Note that, in order for the wireless IC tag B1 to receive the information signal from the reader/writer device B2, the difference fd between the center frequencies of the high-frequency signal P1 and the high-frequency signal P2 has to be made larger than a maximum value of the frequency that forms the information signal. In other words, the difference fd between the center frequencies has to be made larger than a width of the sideband waves of the high-frequency signal P1 including the information signal.

Further, in both cases of FIG. 3A where the frequency f1 of the high-frequency signal P1 is higher than the frequency f2 of the high-frequency signal P2 and FIG. 3B where the frequency of the high-frequency signal P1 is lower than the frequency of the high-frequency signal P2, the filter circuit B18 shuts off the frequency component in a frequency band equal to or higher than the differential frequency fd. Next, the influence which the high-frequency signal P2 output from the high-frequency signal output device B3 gives to the high-frequency signal P1 transmitted from the reader/writer device B2 to the wireless IC tag B1 will be described.

In the international standard specification ISO/IEC 18000-6 mentioned above, the amplitude modulation method is used for the transmission of the information signal from the reader/writer device B2 to the wireless IC tag B1, and a degree of modulation is defined by a ratio of the amplitude of the carrier wave at the time of modulation to the amplitude of the carrier wave at the time of non-modulation and is set to 80 to 100%.

Since the signal obtained by combining the high-frequency signal P1 output from the reader/writer device B2 and the high-frequency signal P2 output from the high-frequency signal output device B3 is supplied to the wireless IC tag B1 in the wireless IC tag system according to the present invention, the signal amplitude at the time of non-modulation is large. However, since the information signal transmitted from the reader/writer device B2 is superposed only on the high-frequency signal P1, the amplitude of the information signal is equal to that of the case where the high-frequency signal output device B3 is not provided.

Therefore, it can be understood that the degree of modulation in the high-frequency signal received by the wireless IC tag B1 is decreased by combining the high-frequency signal P2 with the high-frequency signal P1, and the amplitude of the information signal is further decreased as the signal amplitude of the high-frequency signal P2 received by the wireless IC tag B1 becomes larger than the signal amplitude of the high-frequency signal P1 received by the wireless IC tag B1.

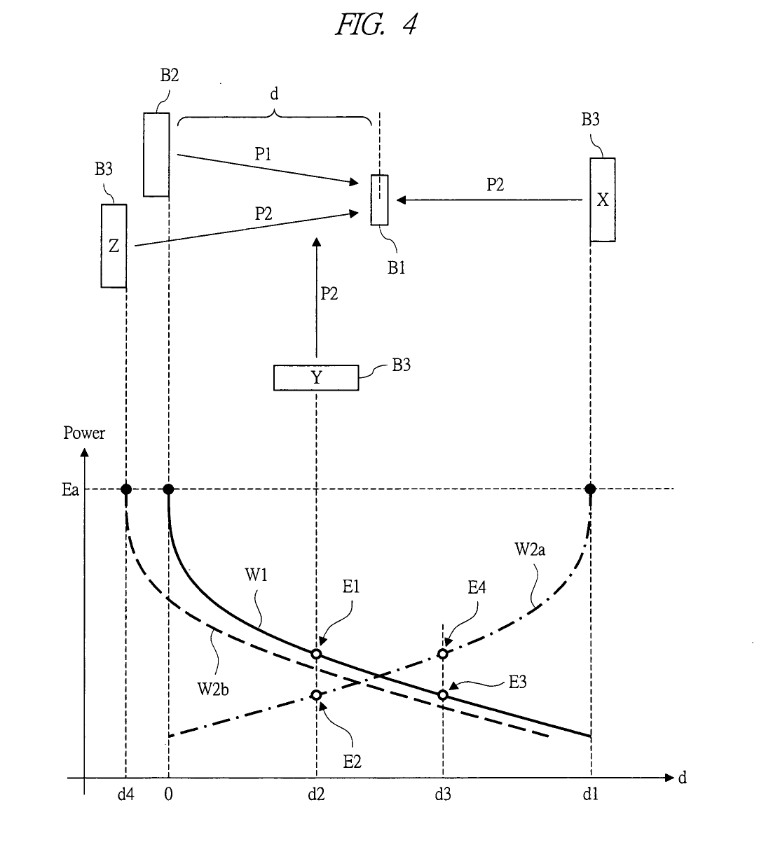

FIG. 4 shows an example of a positional relationship between the reader/writer device B2 and the high-frequency signal output device B3 and an electric field strength in the wireless IC tag system according to the present invention. More specifically, a positional relationship between the wireless IC tag B1 and the high-frequency signal output device B3 with respect to the distance d based on the installation position of the reader/writer device B2 and the electric field strength of the high-frequency signals P1 and P2 received by the wireless IC tag B1 are shown here, and a vertical axis (electric power) is expressed in a logarithm manner. In this case, the characteristics in the case where a reflection of the radio wave and the like are not considered are shown, and an output power of the reader/writer device B2 and the high-frequency signal output device B3 is set to Ea.

In the case where the high-frequency signal output device B3 is opposed to the reader/writer device B2 with interposing the wireless IC tag B1 therebetween and is located at a position X at a distance d1 from the reader/writer device B2, the high-frequency signal P2 output from the high-frequency signal output device B3 is changed in accordance with the distance, and its propagation characteristic is as shown by W2a. On the other hand, the high-frequency signal P1 output from the reader/writer device B2 is changed in accordance with the distance, and its propagation characteristic is as shown by W1.

At this time, in the case where the wireless IC tag B1 is located at a position at a distance d2 from the reader/writer device B2, an electric field strength E2 of the high-frequency signal P2 supplied from the high-frequency signal output device B3 becomes smaller in comparison with an electric field strength E1 of the high-frequency signal P1 supplied from the reader/writer device B2.

Accordingly, the amount of decrease in the amplitude change by the information signal output by the reader/writer device B2 is small. In this case, if the wireless IC tag B1 can receive a signal at a degree of modulation smaller than 80 to 100%, for example, a degree of modulation of 50%, the wireless IC tag B1 can receive the information signal.

However, in the case where the wireless IC tag B1 is located at a position at a distance d3 from the reader/writer device B2, an electric field strength E4 of the high-frequency signal P2 supplied from the high-frequency signal output device B3 becomes larger in comparison with an electric field strength E3 of the high-frequency signal P1 supplied from the reader/writer device B2. Accordingly, the amount of decrease in the amplitude change by the information signal output by the reader/writer device B2 is large. At this time, if the degree of modulation of the information signal becomes smaller than the degree of modulation which the wireless IC tag B1 can receive, the wireless IC tag B1 cannot receive the information signal.

By utilizing the characteristics mentioned above, for example, in the case where the reflection of the radio wave by the peripheral environment affects only near the position at the distance d2 from the reader/writer device B2 and the receiving power of the wireless IC tag B1 is decreased, the receiving power of the wireless IC tag B1 can be improved by the high-frequency signal output device B3 and a communication accuracy can be improved.

Further, in the case where the reflection of the radio wave by the peripheral environment affects only near the position at the distance d2 from the reader/writer device B2 and the receiving power of the wireless IC tag B1 is decreased similarly to the case mentioned above, the receiving power of the wireless IC tag B1 near the position at the distance d2 from the reader/writer device B2 can be improved and the communication accuracy can be improved by installing the high-frequency signal output device B3 at a position Y and adjusting the distance to the wireless IC tag B1 or the like.

In the case where the high-frequency signal output device B3 is arranged in the same direction as the reader/writer device B2 with respect to the wireless IC tag B1 and is located at a position Z backward only by a distance d4 from the reader/writer device B2, the high-frequency signal P2 output from the high-frequency signal output device B3 is changed in accordance with the distance from the wireless IC tag B1, and its propagation characteristic is as shown by W2b. On the other hand, the high-frequency signal P1 output from the reader/writer device B2 is changed in accordance with the distance from the wireless IC tag B1, and its propagation characteristic is as shown by W1.

At this time, whatever distance the wireless IC tag B1 is located from the reader/writer device B2, the electric power supplied from the reader/writer device B2 is maintained larger than the electric power supplied from the high-frequency signal output device B3. Accordingly, the amount of decrease in the amplitude change by the information signal output by the reader/writer device B2 can be maintained small, and if the wireless IC tag B1 can receive a signal at the degree of modulation smaller than 80 to 100%, for example, at the degree of modulation of about 50%, the wireless IC tag B1 can receive the information signal.

By utilizing the characteristics mentioned above, for example, in the case where it is desired to extend the maximum communication distance, the receiving power of the wireless IC tag B1 can be improved by the high-frequency signal output device B3 and a communication distance can be extended while suppressing the amount of decrease in the information signal transmitted from the reader/writer device B2 in all the communication regions. In particular, in the case where the articles to which the wireless IC tag B1 is attached are moved by a belt conveyor or the like, even if a communication impossible region generated by the influence of the peripheral environment or the like exists within the maximum communication possible region, it is possible to transmit and receive the information signal to and from all the wireless IC tags B1 because the region in which the reader/writer device B2 can transmit and receive the information signal to and from the wireless IC tag B1 is expanded.

As mentioned above, since the positional relationship among the reader/writer device B2, the high-frequency signal output device B3 and the wireless IC tag B1 affects the amplitude of the information signal transmitted from the reader/writer device B2 to the wireless IC tag B1, it is preferable to decide the position and the output power of the high-frequency signal output device B3 in consideration of a position at which the power received by the wireless IC tag B1 is desired to be increased.

As described above, in the wireless IC tag system shown in FIG. 1, the larger electric power is supplied to the wireless IC tag B1 and the communication accuracy can be improved by giving the sufficient difference between the center frequency f1 of the high-frequency signal P1 output from the reader/writer device B2 and the center frequency f2 of the high-frequency signal P2 output from the high-frequency signal output device B3 and adjusting the positional relationship and the output power level of the reader/writer device B2 and the high-frequency signal output device B3.

Accordingly, in an actual utilizing environment of the wireless IC tag system, the communication accuracy of the wireless IC tag B1 can be easily improved only by adjusting the arrangement position and the output power level of the high-frequency signal output device B3 at the time when or after deciding the arrangement of the wireless IC tag B1 and the reader/writer device B2.

### Second Embodiment

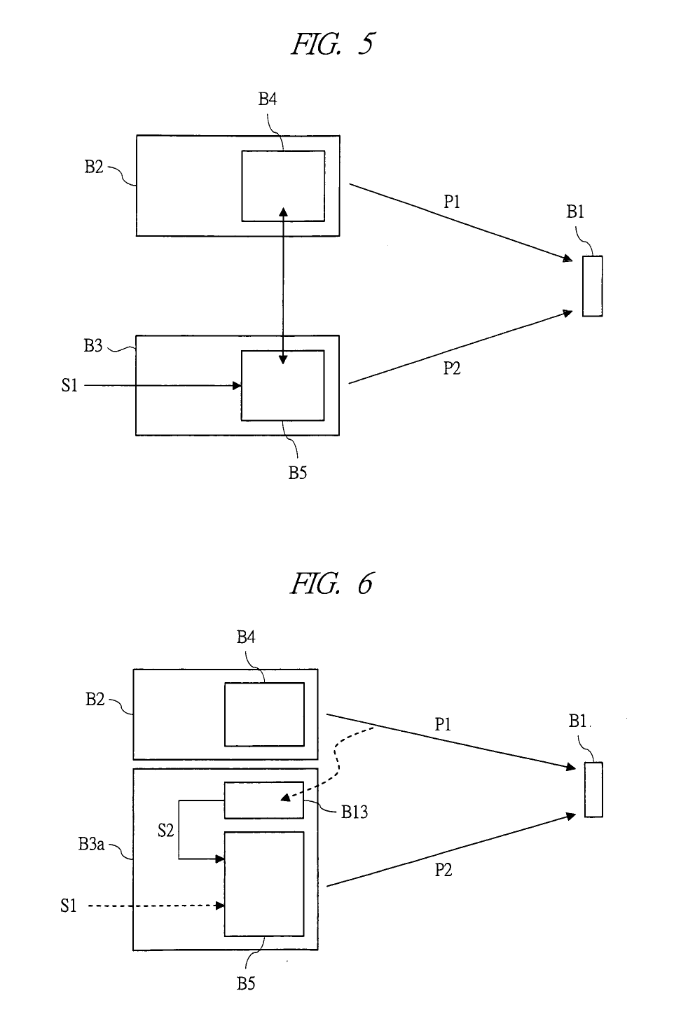

FIG. 5 shows a basic configuration of the wireless IC tag system according to a second embodiment of the present invention. In FIG. 5, B1 denotes the wireless IC tag, B2 denotes the reader/writer device, and B3 denotes the high-frequency signal output device.

The wireless IC tag B1 receives the high-frequency signal P1 supplied in a form of a radio wave from the reader/writer device B2 and the high-frequency signal P2 supplied in a form of a radio wave from the high-frequency signal output device B3. Further, the wireless IC tag B1 demodulates the information signal superposed on the high-frequency signal P1, superposes the result of the signal processing performed in accordance with the information signal transmitted from the reader/writer device B2 on the high-frequency signal P1, and then returns the signal to the reader/writer device B2.

The reader/writer device B2 is provided with the output circuit B4 composed of an antenna and an antenna drive circuit, and outputs the high-frequency signal P1. Further, an information signal by which the reader/writer device B2 reads out the data retained by the wireless IC tag B1, an information signal by which the reader/writer device B2 writes the data in the wireless IC tag B1, and the like are superposed on the high-frequency signal P1.

The high-frequency signal output device B3 is provided with the output circuit B5 composed of an antenna and an antenna drive circuit, and outputs the high-frequency signal P2. The high-frequency signal P2 is output during a period when the high-frequency signal P1 output from the reader/writer device B2 is being output, and is controlled so that an output period of the high-frequency signal P2 is synchronized with an output period of the high-frequency signal P1, by a signal or the like in a wireless or wired form. Further, the output circuit B5 is configured to control an output level and a frequency of the high-frequency signal P2 by a control signal S1 supplied from outside.

With the configuration described above, since the high-frequency signal output device B3 can easily change the output level of the high-frequency signal P2, the degree of freedom with respect to the positional relationship between the reader/writer device B2 and the high-frequency signal output device B3 can be improved.

### Third Embodiment

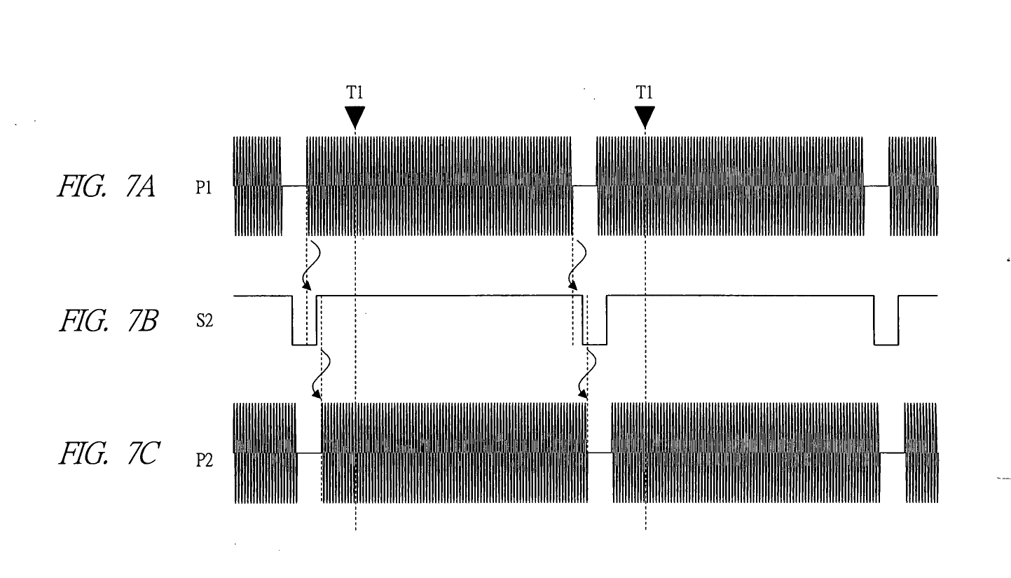

FIG. 6 shows a basic configuration of the wireless IC tag system according to a third embodiment of the present invention. Further, FIG. 7 shows an example of a control waveform of the high-frequency signals P1 and P2 in the wireless IC tag system shown in FIG. 6. In FIG. 7, FIG. 7A shows the high-frequency signal P1 output by the reader/writer device B2, FIG. 7B shows a control signal S2 output by a radio wave detection circuit B13, and FIG. 7C shows the high-frequency signal P2 output by a high-frequency signal output device B3a, respectively.

In FIG. 6, B1 denotes the wireless IC tag, B2 denotes the reader/writer device, and B3a denotes the high-frequency signal output device.

The reader/writer device B2 is provided with the output circuit B4 composed of an antenna and an antenna drive circuit, and outputs the high-frequency signal P1. Further, an information signal by which the reader/writer device B2 reads out the data retained by the wireless IC tag B1, an information signal by which the reader/writer device B2 writes the data in the wireless IC tag B1, and the like are superposed on the high-frequency signal P1.

The high-frequency signal output device B3a is provided with the output circuit B5 composed of an antenna and an antenna drive circuit and is also provided with the radio wave detection circuit B13 for detecting the presence and absence of the high-frequency signal P1 output from the reader/writer device B2. Further, it is also preferable that the output circuit B5 is configured to control an output level and a frequency of the high-frequency signal P2 by the control signal S1 supplied from outside.

The output circuit B5 is controlled by the control signal S2 output from the radio wave detection circuit B13, outputs the high-frequency signal P2 when the radio wave detection circuit B13 detects that the high-frequency signal P1 is output, and stops the output of the high-frequency signal P2 when the radio wave detection circuit B13 detects that the high-frequency signal P1 is not output as shown in FIG. 7.

However, the high-frequency signal output device B3a is configured to start outputting the high-frequency signal P2 before the time T1 at which the reader/writer device B2 starts transmitting the information signal to the wireless IC tag B1. Further, since the radio wave detection circuit B13 has a function to detect the presence and absence of the high-frequency signal P1, it is set up so as not to detect the high-frequency signal P2 output by the high-frequency signal output device B3a.

With the configuration described above, since the high-frequency signal output device B3a can output the high-frequency signal P2 only during the period when the high-frequency signal P1 output from the reader/writer device B2 is being output. Accordingly, since the high-frequency signal P1 and the high-frequency signal P2 can be supplied to the wireless IC tag B1 when the reader/writer device B2 transmits and receives the information signal to and from the wireless IC tag B1, the electric power received by the wireless IC tag B1 is increased, and a stable operation can be achieved.

Further, since the high-frequency signal output device B3a can stop the output of the high-frequency signal P2 during the period when the reader/writer device B2 does not output the high-frequency signal P1, the low electric power consumption can also be achieved.

### Forth Embodiment

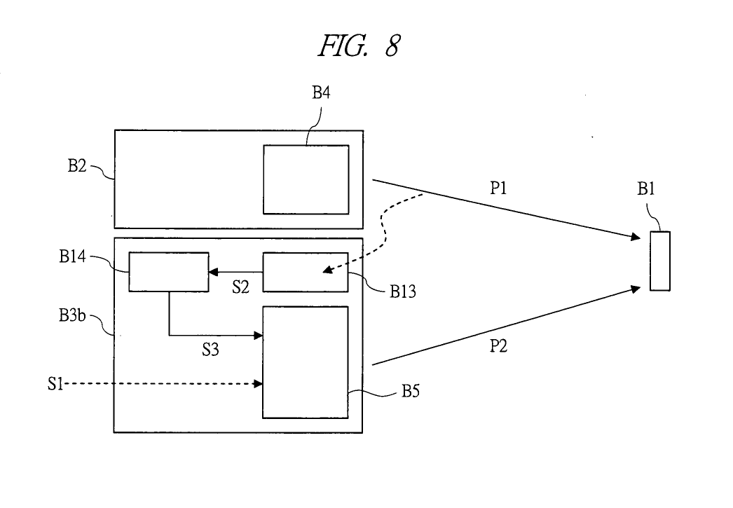

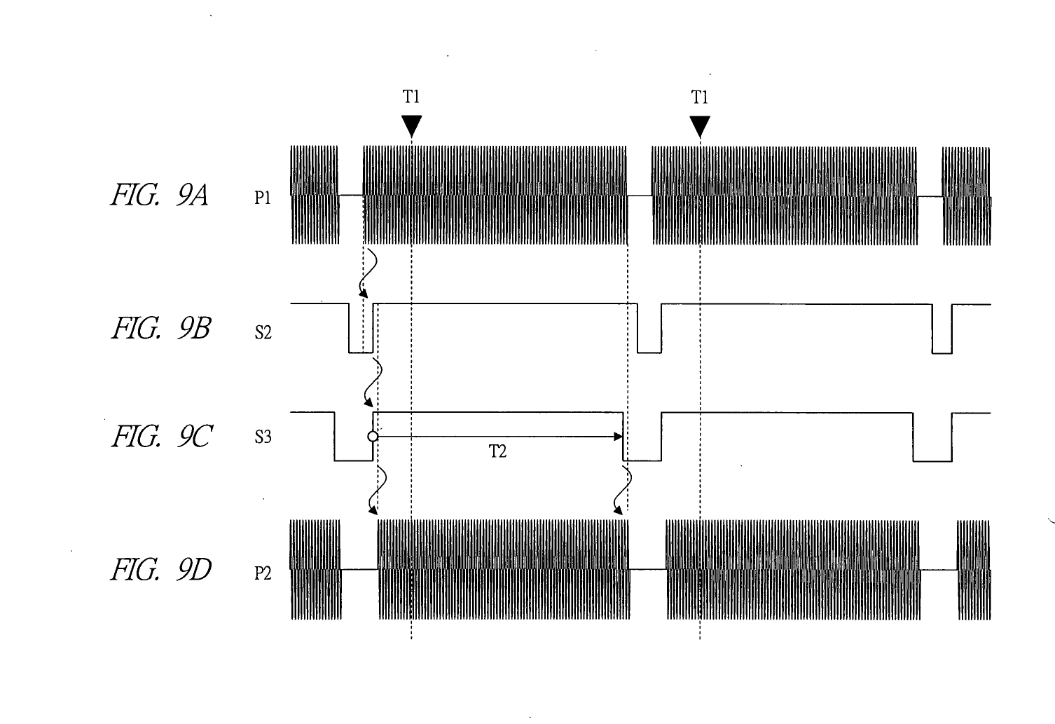

FIG. 8 shows a basic configuration of the wireless IC tag system according to a forth embodiment of the present invention. Further, FIG. 9 shows an example of a control waveform of the high-frequency signals P1 and P2 in the wireless IC tag system shown in FIG. 8. In FIG. 9, FIG. 9A shows the high-frequency signal P1 output by the reader/writer device B2, FIG. 9B shows the control signal S2 output by the radio wave detection circuit B13, FIG. 9C shows a control signal S3 output by an output time controller B14, and FIG. 9D shows the high-frequency signal P2 output by a high-frequency signal output device B3b, respectively.

In FIG. 8, B1 denotes the wireless IC tag, B2 denotes the reader/writer device, and B3b denotes the high-frequency signal output device.

The reader/writer device B2 is provided with the output circuit B4 composed of an antenna and an antenna drive circuit, and outputs the high-frequency signal P1. Further, an information signal by which the reader/writer device B2 reads out the data retained by the wireless IC tag B1, an information signal by which the reader/writer device B2 writes the data in the wireless IC tag B1, and the like are superposed on the high-frequency signal P1.

The high-frequency signal output device B3b is provided with the output circuit B5 composed of an antenna and an antenna drive circuit and is also provided with the radio wave detection circuit B13 for detecting the presence and absence of the high-frequency signal P1 output from the reader/writer device B2 and the output time controller B14. Further, it is also preferable that the output circuit B5 is configured to control an output level and a frequency of the high-frequency signal P2 by the control signal S1 supplied from outside.

The output circuit B5 is controlled by the control signal S3 output from the output time controller B14, starts outputting the high-frequency signal P2 when the radio wave detection circuit B13 detects that the high-frequency signal P1 is output, and stops the output of the high-frequency signal P2 when an output time T2 has elapsed after the start of the output of the high-frequency signal P2 as shown in FIG. 9. At this time, the output time T2 of the high-frequency signal P2 may be set to be equal to the time for which the reader/writer device B2 outputs the high-frequency signal P1.

However, the high-frequency signal output device B3b is configured to start outputting the high-frequency signal P2 before the time T1 at which the reader/writer device B2 starts transmitting the information signal to the wireless IC tag B1.

With the configuration described above, since the high-frequency signal output device B3b can output the high-frequency signal P2 only during the period when the high-frequency signal P1 is being output from the reader/writer device B2. Accordingly, since the high-frequency signal P1 and the high-frequency signal P2 can be supplied to the wireless IC tag B1 when the reader/writer device B2 transmits and receives the information signal to and from the wireless IC tag B1, the electric power received by the wireless IC tag B1 is increased, and a stable operation can be achieved.

Further, since the high-frequency signal output device B3b can stop the output of the high-frequency signal P2 during the period when the reader/writer device B2 does not output the high-frequency signal P1, the low electric power consumption can also be achieved.

Further, unlike the configuration shown in FIG. 6, since the time to stop the output of the high-frequency signal P2 is decided by the output time controller B14, it does not matter if the radio wave detection circuit B13 detects the high-frequency signal P2 output by the high-frequency signal output device B3b. Accordingly, the configuration of the radio wave detection circuit B13 is simplified, and the size reduction and the low electric power consumption can be easily achieved.

### Fifth Embodiment

FIG. 10 shows a basic configuration of the wireless IC tag system according to a fifth embodiment of the present invention. In FIG. 10, B1 denotes the wireless IC tag, B2a denotes a reader/writer device, and B3 denotes the high-frequency signal output device.

The reader/writer device B2a is provided with the output circuit B4 composed of an antenna and an antenna drive circuit and an output controller B15, and whether the high-frequency signal P1 is output is controlled by a control signal S4 output by the output controller B15. Further, an information signal by which the reader/writer device B2a reads out the data retained by the wireless IC tag B1, an information signal by which the reader/writer device B2a writes the data in the wireless IC tag B1, and the like are superposed on the high-frequency signal P1.

The high-frequency signal output device B3 is provided with the output circuit B5 composed of an antenna and an antenna drive circuit, and the output circuit B5 is controlled by the control signal S4 of the output controller B15 provided in the reader/writer device B2a and outputs the high-frequency signal P2 at a time when the reader/writer device B2a outputs the high-frequency signal P1. Further, it is also preferable that the output circuit B5 is configured to control an output level and a frequency of the high-frequency signal P2 by the control signal S1 supplied from outside.

With the configuration described above, the high-frequency signal output device B3 can output the high-frequency signal P2 in synchronization with the high-frequency signal P1 output from the reader/writer device B2a. Accordingly, since the high-frequency signal P1 and the high-frequency signal P2 can be supplied to the wireless IC tag B1 when the reader/writer device B2a reads the data from the wireless IC tag B1, the electric power received by the wireless IC tag B1 is increased, and a stable operation can be achieved.

Further, unlike the configurations shown in FIG. 6 (third embodiment) and FIG. 8 (forth embodiment), it is not necessary to detect the radio wave in the high-frequency signal output device B3 of the fifth embodiment. Accordingly, since the configuration of the high-frequency signal output device B3 is simplified and a time delay for detecting the presence and absence of the radio wave is not generated, the output periods of the high-frequency signal P1 and the high-frequency signal P2 can be securely synchronized.

### Sixth Embodiment

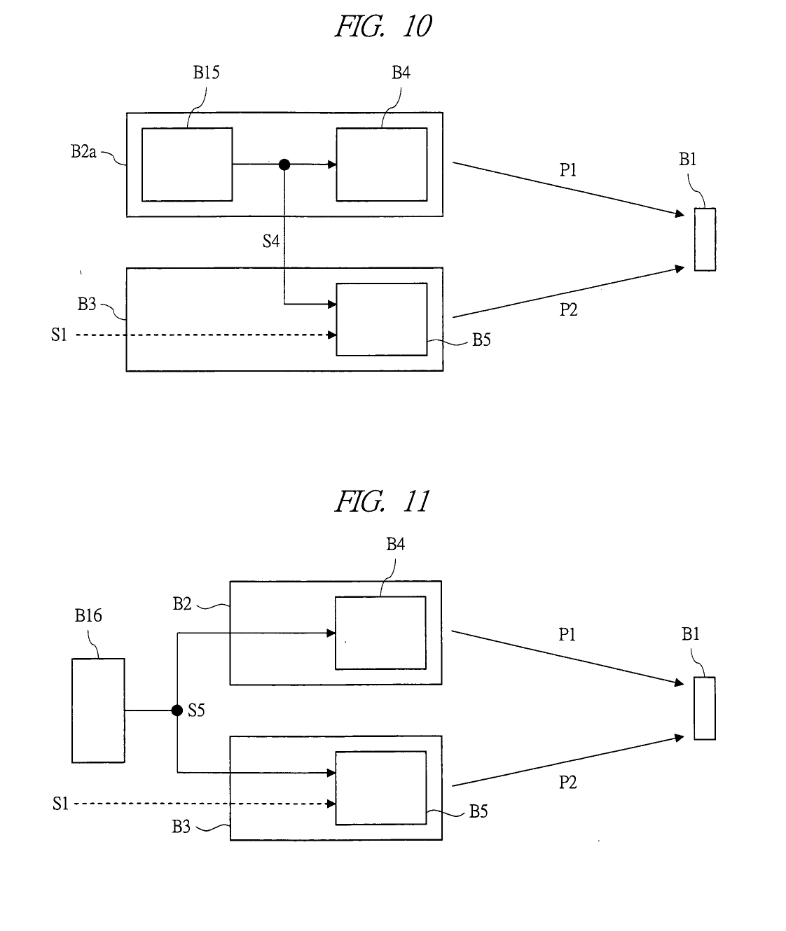

FIG. 11 shows a basic configuration of the wireless IC tag system according to a sixth embodiment of the present invention. In FIG. 11, B1 denotes the wireless IC tag, B2 denotes the reader/writer device, B3 denotes the high-frequency signal output device, and B16 denotes an output controller.

The reader/writer device B2 is provided with the output circuit B4 composed of an antenna and an antenna drive circuit, and outputs the high-frequency signal P1. Further, an information signal by which the reader/writer device B2 reads out the data retained by the wireless IC tag B1, an information signal by which the reader/writer device B2 writes the data in the wireless IC tag B1, and the like are superposed on the high-frequency signal P1.

The high-frequency signal output device B3 is provided with the output circuit B5 composed of an antenna and an antenna drive circuit, and outputs the high-frequency signal P2. Further, it is also preferable that the output circuit B5 is configured to control an output level and a frequency of the high-frequency signal P2 by the control signal S1 supplied from outside.

In this case, in both of the output circuit B4 provided in the reader/writer device B2 and the output circuit B5 provided in the high-frequency signal output device B3, output periods of the high-frequency signals P1 and P2 are controlled by the control signal S5 output by the output controller B16.

With the configuration described above, the high-frequency signal output device B3 can output the high-frequency signal P2 in synchronization with the high-frequency signal P1 output from the reader/writer device B2. Accordingly, since the high-frequency signal P1 and the high-frequency signal P2 can be supplied to the wireless IC tag B1 when the reader/writer device B2 transmits and receives the information signal to and from the wireless IC tag B1, the electric power received by the wireless IC tag B1 is increased, and a stable operation can be achieved.

Further, similar to the configuration shown in FIG. 10 (fifth embodiment), the high-frequency signal output device B3 is not required to detect the radio wave. Accordingly, since the configuration of the high-frequency signal output device B3 is simplified and a time delay for detecting the presence and absence of the radio wave is not generated, the output periods of the high-frequency signal P1 and the high-frequency signal P2 can be more securely synchronized.

### Seventh Embodiment

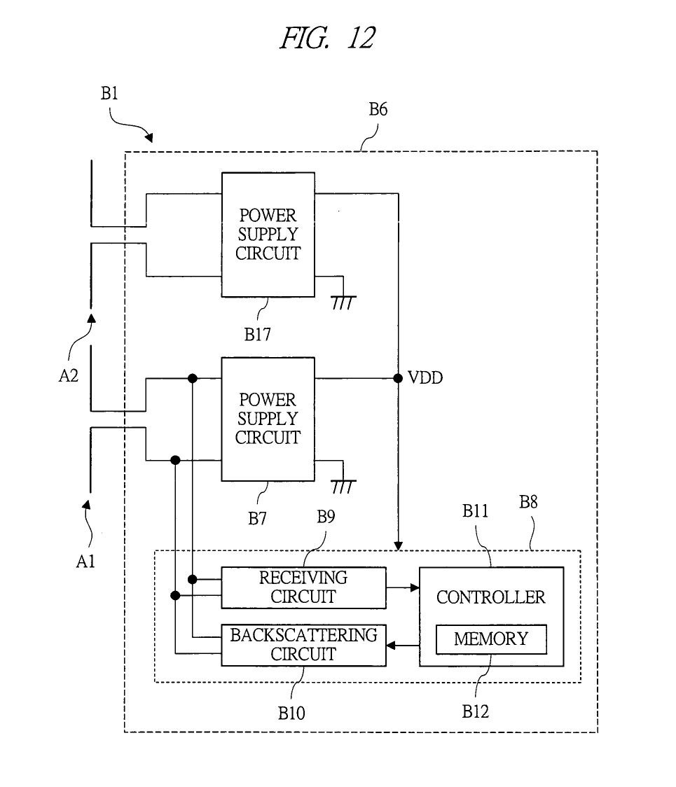

FIG. 12 shows another configuration example of the wireless IC tag B1. The wireless IC tag B1 is composed of antennas A1 and A2 and an IC chip B6, and the IC chip B6 is provided with power supply circuits B7 and B17 and an internal circuit B8. In other words, the antenna A2 and the power supply circuit B17 are added to the configuration of the wireless IC tag B1 shown in FIG. 2.

The power supply circuit B7 rectifies the high-frequency signal received by the antenna A1 provided in the wireless IC tag and smoothes the rectified signal with a smoothing capacitor, thereby obtaining a power supply voltage VDD supplied to the internal circuit B8. Further, a regulator circuit to control the power supply voltage VDD so as not to reach a predetermined voltage or higher may be provided.

The power supply circuit B17 rectifies the high-frequency signal received by the antenna A2 provided in the wireless IC tag, smoothes the rectified signal with a smoothing capacitor and adds the resultant voltage to the power supply voltage VDD output by the power supply circuit B7. At this time, since the output voltages of the power supply circuit B7 and the power supply circuit B17 are supplied in a combined form to the internal circuit B8, it is preferable to share the smoothing capacitor and the regulator circuit of the power supply circuit B17 with the regulator circuit provided in the power supply circuit B7.

The internal circuit B8 is composed of the receiving circuit B9, the backscattering circuit B10 and the controller B11, and the controller B11 is provided with the memory B12 and the like so as to achieve the same function as that in FIG. 2.

In the configuration of the wireless IC tag B1 shown in FIG. 12, the antenna A1 receives the high-frequency signal P1 supplied from the reader/writer device B2, and the antenna A2 receives the high-frequency signal P2 supplied from the high-frequency signal output device B3.

By providing the antenna A1 and the antenna A2 in the wireless IC tag B1 as described above, even in the case where the frequencies of the high-frequency signal P1 and the high-frequency signal P2 are significantly different from each other, antennas suitable for the respective frequencies can be applied to the antennas A1 and A2.

By this means, the deterioration of the receiving power of the wireless IC tag B1 caused due to the relation between the antenna characteristics and the high-frequency signals P1 and P2 can be prevented.

With the configuration described above, since the high-frequency signal P1 output from the reader/writer device B2 and the high-frequency signal P2 output from the high-frequency signal output device B3 are supplied to the wireless IC tag B1, the electric power received by the wireless IC tag B1 can be increased.

In the foregoing, the invention made by the inventors of the present invention has been concretely described based on the embodiments. However, it is needless to say that the present invention is not limited to the foregoing embodiments and various modifications and alterations can be made within the scope of the present invention. Further, the first to seventh embodiments described above can be appropriately combined.

For example, it is possible to transmit the control signal S5 in FIG. 11 (sixth embodiment) to the reader/writer device B2 and the high-frequency signal output device B3 in a wireless form, and it is also possible to utilize a plurality of high-frequency signal output devices outputting high-frequency signals having different frequencies.

The present invention can be preferably applied to the wireless IC tag system or the like that achieves the transmission and reception of the data in a form of electromagnetic wave.

What is claimed is:

1. A wireless IC tag comprising:
an antenna;
a power supply circuit; and
a demodulation circuit,
wherein the antenna receives a first radio wave obtained by amplitude modulating a carrier wave having a first frequency by an information signal and a second radio wave having a second frequency,
wherein the power supply circuit generates a power supply voltage from a signal induced in the antenna by the first radio wave and the second radio wave, and
wherein the demodulation circuit demodulates the information signal from the signal.

2. The wireless IC tag according to claim 1,
wherein the first frequency and the second frequency belong to a frequency band defined by the same standard specification, and
wherein the first frequency and the second frequency belong to respectively different channels.

3. The wireless IC tag according to claim 1,
wherein radio waves of a plurality of channels within a frequency band from 860 MHz to 960 MHz are received by the one antenna.

4. The wireless IC tag according to claim 1,
wherein an electric field strength of the first radio wave reaching the wireless IC tag is higher than an electric field strength of the second radio wave.

5. A wireless IC tag system comprising:
a wireless IC tag;
a first transmitting device for transmitting a first radio wave obtained by amplitude modulating a carrier wave having a first frequency by an information signal to the wireless IC tag; and
a second transmitting device for transmitting a second radio wave having a second frequency to the wireless IC tag,
wherein the wireless IC tag has an antenna, a power supply circuit and a demodulation circuit,
wherein the antenna receives the first radio wave and the second radio wave,
wherein the power supply circuit generates a power supply voltage from a signal induced in the antenna by the first radio wave and the second radio wave, and
wherein the demodulation circuit demodulates the information signal from the signal.

6. The wireless IC tag system according to claim 5,
wherein the first frequency and the second frequency belong to a frequency band defined by the same standard specification, and
wherein the first frequency and the second frequency belong to respectively different channels.

7. The wireless IC tag system according to claim 5,
wherein radio waves of a plurality of channels within a frequency band from 860 MHz to 960 MHz are received by the one antenna.

8. The wireless IC tag system according to claim 5,
wherein an electric field strength of the first radio wave reaching the wireless IC tag system is higher than an electric field strength of the second radio wave.

9. The wireless IC tag system according to claim 5,
wherein an output level and a frequency of the second radio wave are controlled by a control signal from outside.

10. The wireless IC tag system according to claim 5,
wherein the second transmitting device has a detection circuit for detecting presence and absence of transmission of the first radio wave from the first transmitting device,
wherein the second transmitting device starts transmitting the second radio wave when the detection circuit detects that the first radio wave is transmitted, and
wherein the second transmitting device stops transmitting the second radio wave when the detection circuit detects that the first radio wave is not transmitted.

11. The wireless IC tag system according to claim 5,
wherein the second transmitting device has a detection circuit for detecting presence and absence of transmission of the first radio wave from the first transmitting device,
wherein the second transmitting device starts transmitting the second radio wave when the detection circuit detects that the first radio wave is transmitted, and
wherein the second transmitting device stops transmitting the second radio wave when a predetermined time has elapsed after starting transmission of the second radio wave.

12. The wireless IC tag system according to claim 5,
wherein a control signal from the first transmitting device controls start and stop of transmission of the second radio wave from the second transmitting device.

13. The wireless IC tag system according to claim 5, further comprising a control device,
wherein the control device controls start and stop of transmission of the second radio wave from the second transmitting device.

14. An operation method for a wireless IC tag,
wherein, to a wireless IC tag that receives a first radio wave having a first frequency and a second radio wave having a second frequency by an antenna, generates a power supply voltage from a signal induced in the antenna and demodulates an information signal from the signal, a first radio wave obtained by amplitude modulating a carrier wave having the first frequency by the information signal is transmitted from a first transmitting device, and
wherein a second radio wave having the second frequency is transmitted from a second transmitting device to the wireless IC tag.

15. The operation method for a wireless IC tag according to claim 14,
wherein the first frequency and the second frequency belong to a frequency band defined by the same standard specification, and
wherein the first frequency and the second frequency belong to respectively different channels.

16. The operation method for a wireless IC tag according to claim 14,
wherein radio waves of a plurality of channels within a frequency band from 860 MHz to 960 MHz are received by the one antenna.

17. The operation method for a wireless IC tag according to claim 14,
wherein an output level and a frequency of the second radio wave are controlled by a control signal from outside.

18. The operation method for a wireless IC tag according to claim 14,
wherein the second transmitting device has a detection circuit for detecting presence and absence of transmission of the first radio wave from the first transmitting device,
wherein the second transmitting device starts transmitting the second radio wave when the detection circuit detects that the first radio wave is transmitted, and
wherein the second transmitting device stops transmitting the second radio wave when the detection circuit detects that the first radio wave is not transmitted.

19. The operation method for a wireless IC tag according to claim 14,
wherein the second transmitting device has a detection circuit for detecting presence and absence of transmission of the first radio wave from the first transmitting device,
wherein the second transmitting device starts transmitting the second radio wave when the detection circuit detects that the first radio wave is transmitted, and
wherein the second transmitting device stops transmitting the second radio wave when a predetermined time has elapsed after starting transmission of the second radio wave.

20. The operation method for a wireless IC tag according to claim 14,
wherein a control signal from the first transmitting device controls start and stop of transmission of the second radio wave from the second transmitting device.
